(19) United States
(12) Patent Application Publication
(10) Pub. No.: US 2009/0187504 A1
(43) Pub. Date: Jul. 23, 2009

(54) NON-TRADITIONAL FUTURES CONTRACT AND ASSOCIATED PROCESSING SYSTEMS

(75) Inventor: Kris E. Monaco, Richmond Hill, NY (US)

Correspondence Address: WEITZMAN LAW OFFICES, LLC, 425 EAGLE ROCK AVENUE, SUITE 102, ROSELAND, NJ, 07068, US

(73) Assignee: TRADEDEVIL, INC., Richmond Hill, NY (US)

(21) Appl. No.: 12/254,856

(22) Filed: Oct. 21, 2008

Related U.S. Application Data
(60) Provisional application No. 61/022,467, filed on Jan. 21, 2008.

(51) Int. Cl. G06Q 40/00

(52) U.S. Cl. 705/37

(57) ABSTRACT

A computer implemented method and system is disclosed for trading a non-traditional futures contract representative of a price of an individual underlying commodity and/or an option on such a contract. The method and system comprises receiving a request from a customer to establish a position in the non-traditional futures contract of an individual underlying commodity. A contract price of the non-traditional futures contract is determined based on the current market price of the individual underlying commodity. The system and method determine whether available funds within an account corresponding to the customer exceed a predetermined amount. The non-traditional futures contract for the individual underlying commodity is established without any obligation to deliver or receive the commodity. The difference between the contract price and the market price of the individual underlying commodity at the expiration of the contract is calculated and the customer's account is settled based on the difference between the contract price and the market price of the individual underlying commodity at the expiration of the contract.

### CROSS-REFERENCE TO RELATED APPLICATION

This application claims the benefit of U.S. Provisional Patent Application No. 61/022,467, filed Jan. 21, 2008, the entire disclosure of which is incorporated by reference herein.

### FIELD

This application relates generally to non-traditional futures contracts, and more particularly, to futures contracts and options on futures contracts that provide investors with exposure to the price movement of individual commodities and are more accessible to non-institutional customers than traditional futures contracts.

### BACKGROUND

Professional investors have long used several types of derivative investment vehicles to gain exposure to commodity prices. Those instruments, which include commodity futures contracts and commodity options on futures, are typically used for risk management, as well as speculation.

For many years, the main users of futures contracts have been large institutional investors and farmers that produced agricultural commodities, precious metals and livestock. Those producers would use futures contracts to manage the risks associated with unfavorable price changes in commodities. Specifically, commodity producing firms and farmers would “hedge” against a drop in prices by selling futures contracts to speculators or other natural hedgers. The result was that producers would, in effect, establish a favorable price for their products in advance by locking them in with futures contracts. The contracts were agreements to deliver the actual physical commodities at a future date and at a specified location. If commodity prices declined, then the producing firms and farmers were protected against the decline, since the revenues received from futures contracts offset the lower market price received from selling the commodities through normal channels of trade. Alternatively, if commodity prices increased, then the producers and farmers would sell their commodities at higher prices, which would offset the losses incurred under their futures contracts.

Speculators accounted for a significant portion of futures contract purchases. They would purchase futures contracts with the expectation that commodity prices would increase by the future delivery date specified in the contract. Similar to farmers, other natural hedgers were also active purchasers of futures contracts because they needed to purchase raw materials for their own products. For example, grain processors might use futures contracts for grain to protect themselves against an increase in the price of grain. Similarly, jewelry manufacturers might use futures contracts for gold to lock in the price of gold and protect themselves against a future increase in the price of gold.

Options on futures added a new dimension to futures markets by allowing investors to purchase a contract that provided the right to buy or sell an underlying futures contract at a specified price within a certain amount of time. Sellers of options contracts were obligated to buy or sell the underlying futures contract.

The standardized nature of the contracts, as well as the growing number of professionals using them, led to the establishment of organized futures markets. The goal of such markets was to facilitate trading between market participants (i.e., buyers and sellers) by centralizing trading activity and creating a mechanism for counterparty credit risk protection (i.e., the risks associated with one party not fulfilling its contractual obligation to the other). This resulted in highly liquid, centralized futures markets offering a wide array of risk management tools.

Over the past three decades, futures markets continued to innovate by creating financial futures, which used stock indexes, bonds and interest rates as the underlying reference measure. Similar to commodity futures, financial futures offered investors a means to protect against (for hedgers) or get broad exposure to (for speculators) stock market performance, changes in interest rates, etc. Unlike commodity futures, many financial futures contracts were cash-settled because physical delivery was not practical (e.g., in the case of underlying stocks of an index) or was not possible (e.g., in the case of an underlying interest rate). In a cash-settled contract, the counterparties would make a final cash exchange based on the difference between the contract price and the market price at expiration of the contract. This style of settlement offered more flexibility for market participants not equipped to make or take delivery of an underlying commodity, which was potentially a costly process.

Today, futures contracts are traded on regulated futures exchanges, such as the Chicago Mercantile Exchange (“CME”) and New York Mercantile Exchange (“NYMEX”). Each futures exchange has a clearing house that guarantees each trade. Buying or selling futures contracts can only be done through licensed and regulated brokers, and ultimately through a clearing house member of the exchange. Those clearing agents are called futures commission merchants (“FCMs”). Non-members of the exchange trading futures contracts are generally called “customers.” A customer must have an account with a broker to trade futures contracts. Although other types of brokers may handle customer orders, all trading activity and funds must eventually be processed by a FCM.

Futures contracts are sometimes quoted by market makers professional traders that offer firm quotes to buy or sell a certain amount of futures contracts at a specific price. A quote to buy futures contracts is called a “bid” and a quote to sell futures contracts is called an “offer.” The difference between the bid and offer is called the “spread.” The spread allows the market maker to be compensated for ensuring liquidity in the contracts.

Futures contracts are usually purchased on margin, where the buyer is required to deposit a cash performance bond. That amount is well below 10% of the total contract value and is generally referred to as “initial margin.” Once the contract is initially established, cash transfers are made between buyer and seller to take daily contract value changes into account. For example, if the price of a futures contract increases from one day to the next, funds from the selling party are transferred to the purchasing party. If the price decreases, then funds from the purchasing party are transferred to the selling party. The amount is known as “variation margin” and the process of calculating that amount is referred to as “marking to market.” If the funds in a customer's account fall below a certain threshold, then the customer is required to deposit additional funds into the account, which is referred to as “maintenance margin.”

Trading activity in futures contracts today is generally limited to large sophisticated investors due to the high value of these contracts, which are often in excess of tens of thousands of dollars, and the complex limitations and requirements involved in trading futures contracts. For these reasons, futures exchanges cater mostly to institutional investors when considering new tradable instruments.

Although many commodities underlying futures contracts are often the topic of the press and the media regularly references the commodity prices in financial news reports, small investor participation in futures markets today is extremely limited. Rather, small investors tend to limit their investment activity to buying and selling securities, the most popular of which are stocks and stock options listed on registered securities exchanges. Over the past decade, the advent of discount and Internet-based brokers has helped to fuel small investors' interest in stocks and stock options due to declining commissions associated with stock trading. Brokers offering stock and stock options trading compete heavily for this specific investor group by offering associated trading services. Additionally, securities exchanges have become much more efficient by developing electronic trading systems, making the traditional model of manual trade handling virtually obsolete. The result is that trading costs have declined, liquidity has increased, and the number of securities accounts far exceeds the number of futures accounts. Therefore, the distribution potential for a new security product among small investors is much greater than that for a new futures product.

The regulatory structure, and therefore the availability of futures products, is very different from that of securities. Futures exchanges in the U.S. are registered with and regulated by the Commodity Futures Trading Commission (“CFTC”), and futures brokers are registered with and regulated by the National Futures Association (“NFA”). In contrast, securities exchanges are registered with and regulated by the Securities Exchange Commission (“SEC”), and securities brokers are registered with and regulated by the Financial Industry Regulatory Authority (“FINRA”). Both the NFA and FINRA are known as self-regulatory organizations (“SROs”).

Standardized options on futures contracts are a more recent industry innovation, whereby such contracts offer the buyer the right, but not the obligation, to buy or sell a certain number of underlying futures contracts at a fixed price before a specific date. The fixed price is known as the “strike price” and the specific date is known as the “expiration date.” The counterparty to the option buyer (the “option writer”) has an obligation to buy or sell an underlying futures contract at the strike price. The option buyer (referred to as the “option holder”) may elect to buy or sell the underlying futures contract by exercising his or her right. The price of the option itself is referred to as the “premium.”

The two most popular types of options contracts are “calls” and “puts.” A call option grants the option holder the right to purchase an underlying futures contract at a strike price, while the option writer has an obligation to sell the underlying futures contract at that strike price. A put option grants the option holder the right to sell an underlying futures contract at a strike price, while the option writer has an obligation to buy the underlying futures contract at that strike price.

In general, a single options contract provides the option holder with the right to buy or sell a certain number of units of an underlying instrument. In the case of options on futures, each options contract provides for the delivery of one futures contract. In contrast, in the case of options on equities, each options contract provides for the delivery of 100 shares of the underlying stock.

Options on futures contracts are traded in the same accounts as the underlying futures contracts (i.e., through the same intermediaries), are available on the same exchanges as the futures contracts (e.g., CME or NYMEX), and generally use the same clearing house mechanisms as the futures contracts. Therefore, the limitations and complexities perceived by small investors limit their participation in these options on futures products as well.

Considering the limitations of the current market conditions, as well as the bifurcation of regulatory jurisdiction, it is desirable to provide small investors with a new non-traditional futures contract product that provides exposure to commodity prices, but without the complexity and restrictions of traditional futures contracts. More specifically, it is desirable to provide a new non-traditional futures contract product that can be listed by securities exchanges (e.g., stock exchanges) and futures exchanges and be made available to small investors through securities brokers.

Other attempts at giving small investors access to commodity futures have been disclosed, but do not provide investors with access to individual commodity prices or a mechanism for trading options on individual commodity prices. For example, U.S. Pat. Pub. No US 2003/01822219 A1 to Bodurtha et al. discloses an investment vehicle for trading on an exchange licensed to trade futures contracts, whose price reflects the index value of a basket of financial assets. The index value is calculated by a specific, predetermined formula and does not give small investors access to individual commodity prices nor does it provide a mechanism for trading options on individual commodity prices.

Another example is disclosed in U.S. Pat. No. 7,283,978 to Frankel et al, which provides investors access to an interest in a pool of commodities by establishing a legal entity—a commodity pool—to own futures contracts and Treasury securities. Shares of the legal entity may be traded on an exchange, but investors are not provided with access to individual commodity prices or with a mechanism for trading options on individual commodity prices.

U.S. Pat. Pub. No. US 2003/0009415 A1 to Lutnick et al. discloses trading future contracts for intangible assets (i.e., assets having no physical or material manifestation, such as future revenues and royalties from artistic works and future earnings of professional athletes or highly valued professional) on a computer-based futures exchange, but does not provide investors with access to individual commodity prices or with a mechanism for trading options on individual commodity prices.

Therefore, it is desirable to provide a new, non-traditional futures contract and options on such a contract that provides investors with access to individual commodity prices and options on individual commodity prices, which may be listed by a securities exchange, an alternative trading system (“ATS”), and/or futures exchange.

### SUMMARY

A non-traditional futures contract and options overlying that contract, both of which can be implemented via a computer data processing system, are disclosed herein. The non-traditional futures contract provides a future price of a single underlying commodity and is unencumbered by the daily variation margin associated with traditional futures contracts. The non-traditional futures contract, as well as options on that contract, may be listed and made available for trading on a securities exchange or other entity regulated by the SEC or FINRA. The non-traditional futures contract disclosed herein, and options on that contract, may also provide for a daily margin component for short customers.

In one aspect of this disclosure, a computer implemented method and system is disclosed for trading a non-traditional futures contract representative of a price of an individual underlying commodity. The method and system comprises receiving a request from a customer to establish a position in the non-traditional futures contract of an individual underlying commodity. A contract price of the non-traditional futures contract is determined based on the current market price of the individual underlying commodity. The system and method determines whether available funds within an account corresponding to the customer exceed a predetermined amount. The non-traditional futures contract for the individual underlying commodity is established without any obligation to deliver or receive the commodity. The difference between the contract price and the market price of the individual underlying commodity at the expiration of the contract is calculated and the customer's account is settled based on the difference between the contract price and the market price of the individual underlying commodity at the expiration of the contract.

In another aspect of this disclosure, a method and system is disclosed for trading options on an underlying non-traditional futures contract representative of a price of an individual underlying commodity. The method and system comprises receiving a request from a customer to establish a position in an option on the non-traditional futures contract of an individual underlying commodity. A contract price of the underlying non-traditional futures contract is determined based on the current market price of the individual underlying commodity. The system and method determine whether available funds within an account corresponding to the customer exceed a predetermined amount. The option on the non-traditional futures contract for the individual underlying commodity is established without any obligation to deliver or receive the commodity. The system and method calculates the difference between the contract price and the market price of the individual underlying commodity at the expiration of the contract, and the customer's account may be settled based on the difference between the contract price and the market price of the individual underlying commodity at the expiration of the contract if the option is exercised. Alternatively, the customer's account may be settled by delivery of the underlying non-traditional futures contract if the option is exercised.

These and other advantages of the present disclosure will be apparent to those of ordinary skill in the art by reference to the following detailed description and the accompanying drawings.

### BRIEF DESCRIPTION OF THE DRAWINGS

FIG. 1 is a block diagram illustrating the flow of funds between long and short customers of a non-traditional futures contract and options overlying that contract;

FIG. 2 is an illustrative schematic of a computer system for trading non-traditional futures contracts and options overlying that contract;

FIG. 3 is an illustrative network for trading non-traditional futures contracts;

FIG. 3A is another illustrative network for trading non-traditional futures contracts;

FIG. 4 is a flowchart illustrating a preferred sequence of steps for requesting a long position on a non-traditional futures contract;

FIG. 5 is a flowchart illustrating a preferred sequence of steps for requesting a short position on a non-traditional futures contract;

FIG. 6 is a flowchart illustrating a preferred sequence of steps for requesting a long option on a non-traditional futures contract; and,

FIG. 7 is a flowchart illustrating a preferred set of steps for requesting a short option on a non-traditional futures contract.

### DETAILED DESCRIPTION

A novel, non-traditional futures contract (hereinafter “TradeDevil™ contract”), and options underlying that contract, are disclosed herein. The TradeDevil™ contract is an investment vehicle that makes individual commodity prices broadly accessible to investors without the complex characteristics, requirements, and limitations associated with futures contracts. Trading may be conducted through either a futures exchange, securities exchange, or an alternative trading system (“ATS”) designated as such by, for example, the Commodity Futures Trading Commission (“CFTC”) or Securities and Exchange Commission (“SEC”). Clearing and settlement may be conducted through a clearing organization designated as such by the SEC or CFTC. Account management may be performed by either broker-dealers or futures commission merchants.

Each TradeDevil™ contract is preferably tied to the price performance of an individual underlying commodity, such as, for example, gold, crude oil, sugar or livestock. Each TradeDevil™ contract preferably has a value of 1.00 multiplied by the price per unit of the underlying commodity. The commodity grade, quantity and standard unit size can be identical to that specified by an associated futures contract already listed on a futures exchange. For example, West Texas Intermediate (“WTI”) crude oil is quoted as a futures contract on the New York Mercantile Exchange (“NYMEX”) and the Intercontinental Exchange in terms of US dollars and cents per US barrel. Therefore, if a WTI crude oil TradeDevil™ contract is quoted at $90.50 per US barrel, then the value of that TradeDevil™ contract would also be $90.50.

Buying TradeDevil™ contracts provides customers with a “long” position, and selling TradeDevil™ contracts provides customers with a “short” position. Customers with a long position benefit when the price of an underlying commodity increases, while customers with a short position benefit when the price of an underlying commodity decreases.

TradeDevil™ contracts preferably have a stated expiration date and are preferably settled in cash on the expiration date using a final settlement value determined by the exchange or venue that facilitates trading in the contracts. TradeDevil™ contracts do not have to be held until expiration. Customers may close out their position at any time by selling the same amount of contracts in the case of a long position or buying the same amount of contracts in the case of a short position.

TradeDevil™ contracts reduce some of the perceived risks and complexities associated with traditional futures contracts. For example, unlike traditional futures contracts, customers with a long position in TradeDevil™ contracts (i.e., customers who purchase such contracts) cannot incur losses in excess of their initial investment amount to the extent they are required to post 100% of the contract market value at the time of purchase. It is understood, however, that customers taking long positions may, to the extent permitted, be allowed to post an amount less than 100% (e.g., 50%). Additionally, it is preferred that customers with a long position in TradeDevil™ contracts are not subject to margin calls or any other additional payments throughout the life of their position in cases where they post 100% of the contract market value.

In contrast, however, it is preferred that customers with a short position in TradeDevil™ contracts (i.e., customers who sell such contracts) be required to deposit an initial cash performance bond equal to, for example, 50% of the current contract value to maintain 150% of total short sale proceeds and also be subject to the same margin requirements associated with securities transactions.

TradeDevil™ contracts may be implemented as follows. Preferably, TradeDevil™ contracts should receive much of the same transaction support associated with current futures or securities transactions. Brokerage services can be provided by futures commission merchants (“FCMs”) or broker-dealers (“BDs”). The TradeDevil™ contracts may be listed for trading on an exchange or an alternative trading system (“ATS”) licensed to trade futures contracts. Additionally, the trading venue and its affiliates can be responsible for trading and clearing house functions associated with TradeDevil™ contract transactions.

Customers may buy and sell TradeDevil™ contracts through a securities account with a broker-dealer notice registered with, for example, the NFA as an FCM, or through a futures account with a FCM or introducing broker. TradeDevil™ contracts may be listed for trading on a futures exchange registered with the CFTC. TradeDevil™ contracts may also be listed on a securities exchange or any other trading venue that is notice designated with the CFTC as a designated contract market and cleared through a CFTC or SEC designated clearing organization. Trades conducted in TradeDevil™ contracts may be cleared and settled via an organization established as such by the CFTC or SEC.

Options on TradeDevil™ contracts preferably share the same characteristics of the underlying contract in that they are available through the same intermediaries, can be traded on the same venues, and cleared through the same organizations as TradeDevil™ contracts. Options on TradeDevil™ contracts can, for example, provide for the delivery of 100 underlying TradeDevil™ contracts or its cash equivalent.

Options on TradeDevil™ contracts may be listed for trading on a futures exchange registered with the CFTC, a securities exchange, or an ATS designated as such by the SEC. Trades conducted in options on TradeDevil™ contracts are preferably cleared and settled via an organization established as such by the CFTC or SEC. A customer that purchases options on TradeDevil™ contracts (i.e., establishes a long position) may be required to deposit a cash performance bond equal to 100% of the premium. Also, customers with a long position in options on TradeDevil™ contracts may not have daily variation margin requirements.

In contrast, a customer establishing a short position in options on TradeDevil™ contracts (i.e., a customer that sells the option) may be required, for example, to maintain 100% of the sale proceeds plus at least 10% (e.g., 20%) of the current value of the underlying TradeDevil™ contracts less the out-of-the-money amount, if any.

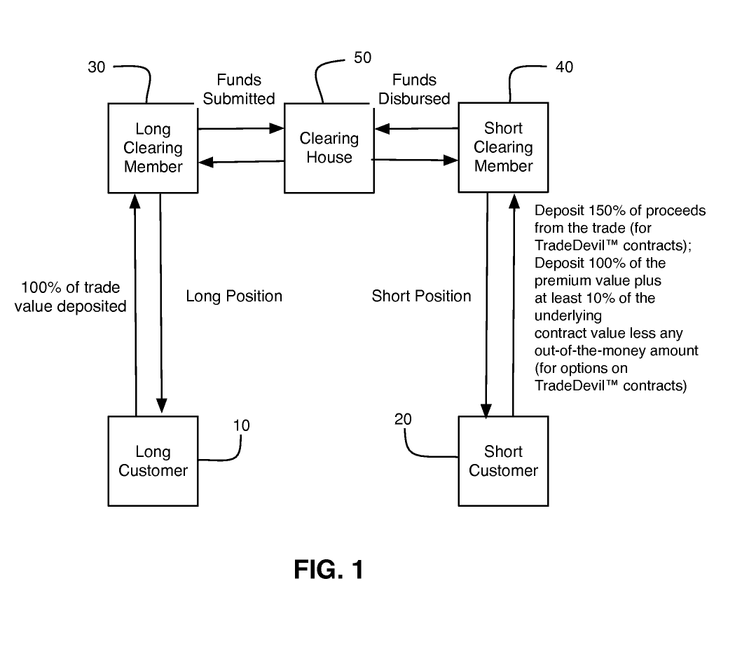

FIG. 1 depicts a block diagram of the major participants of TradeDevil™ contracts and options on such contracts. Each TradeDevil™ contract has a long customer 10 and a short customer 20, where the long customer refers to the buyer of a TradeDevil™ contract and the short customer refers to the seller of the same TradeDevil™ contract. Customers hold investment accounts and interact with brokers. Each broker has a clearing member for implementing a transaction on a designated exchange or other trading venue. Long clearing member 30 and short clearing member 40 preferably maintain communication links to the exchange or trading venue on which TradeDevil™ contracts are traded.

Members can employ computer processing systems for tracking and managing the various accounts implicated by the TradeDevil™ contracts. Communication links are preferably used to facilitate the exchange of information regarding market pricing, trade status, positions and margin balances. Funds may be transferred by wire or via end of day delivery.

The connecting arrows in FIG. 1 reflect the exchange of assets and margin payments between the parties. In accordance with this flow, long customer 10 may, for example, deposit a cash performance bond equal to 100% of the TradeDevil™ contract value. Similarly, short customer 20 may, for example, deposit a cash performance bond equal to 50% of the current TradeDevil™ contract in addition to the total short sale proceeds, resulting in 150% of the total short sale proceeds.

Long customers in options on TradeDevil™ contracts may also deposit a cash performance bond equal to 100% of the options premium. Short customers in options on TradeDevil™ contracts may, for example, deposit a cash performance bond equal to 100% of the options premium plus at least 10% (e.g., 20%) of the underlying TradeDevil™ contract value less the out-of-the-money amount, if any.

In the preferred embodiment, customers will not have any obligation to make, or right to receive, daily variation margin payments. However, under specified circumstances, short customers in TradeDevil™ contracts can make and receive payments to and from the short clearing member generally in accordance with rules applicable to securities transactions using daily settlement prices determined by the exchange. If the daily settlement price increases to a level such that the short customer's performance bond is less than or equal to, for example, 30% of such price, then the short customer may be required to make a maintenance restoration payment to restore the performance bond to 50% of the settlement price. Alternatively, if the settlement price decreases to a level such that the performance bond is equal to or greater than, for example, 70% of the settlement price, then the short customer may receive a maintenance restoration payment to restore the performance bond to 50% of the settlement price.

It is preferred that short customers in options on TradeDevil™ contracts be required to maintain the same initial margin requirements set forth above.

TradeDevil™ contracts are traded on the selected exchange, and the position of all traders is rationalized by the exchange's clearing house 50 via interchange with the various clearing members acting on behalf of customers. At the end of the contract term, TradeDevil™ contracts can be extinguished and the difference between the initial contract price and the settlement price can be exchanged between the parties.

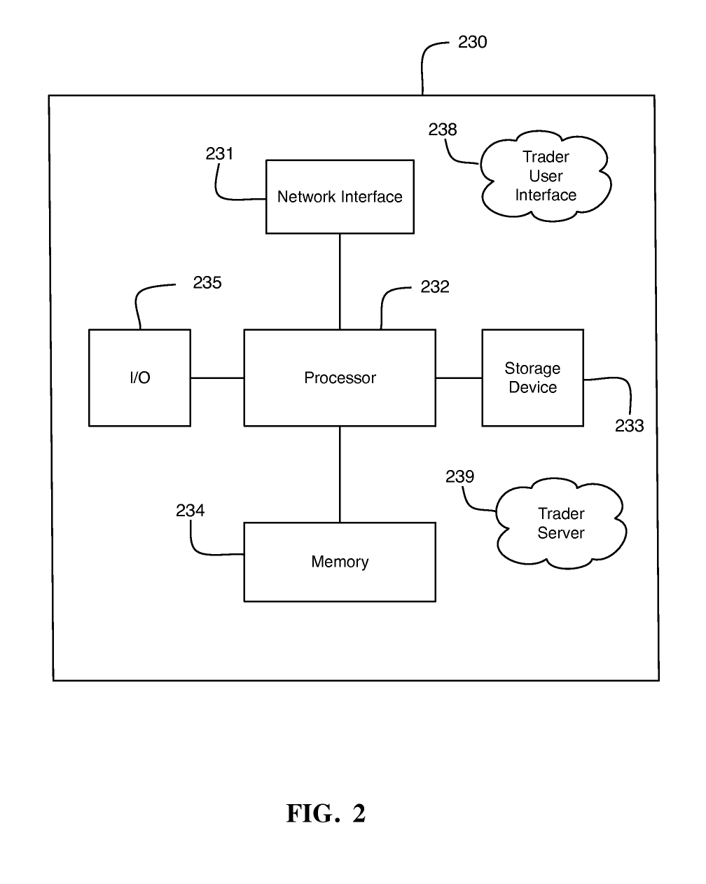

FIG. 2 is a schematic of an illustrative system for trading TradeDevil™ contracts and options in such contracts. Trader workstations are implemented, for example, using computer processors, memory units, storage devices, computer software, and other components. Orders for TradeDevil™ contracts and options on such contracts may be entered via computer system 230 using trader user interface software 238. Trader user interface 238 may contain a series of programming instructions in any known programming language (e.g., Visual C++, C#, Java, etc.). Trader interface software 238 may be stored in storage device 233 (e.g., magnetic hard drive), loaded into memory 234 (e.g., random access memory (“RAM”), and executed by processor 232. Alternatively, trader user interface 238 may be downloaded into memory 234 via the Internet, through network interface 231, and executed by processor 232.

The necessary programming instructions may also be distributed between trader user interface 238 and trader server 239. Trader server 239 may also be a series of programming instructions in any known programming language (e.g., C++, Java, Perl, etc.). Trader user interface 238 and trader server 239 may execute on the same computer system, as illustrated in FIG. 2, or may execute on separate computer systems. Computer system 230 may interact with a trader via input/output (“I/O”) devices 235. One skilled in the art will recognize that an implementation of an actual trader workstation may contain different components or configurations and that FIG. 2 is illustrative of some of the components of such a workstation.

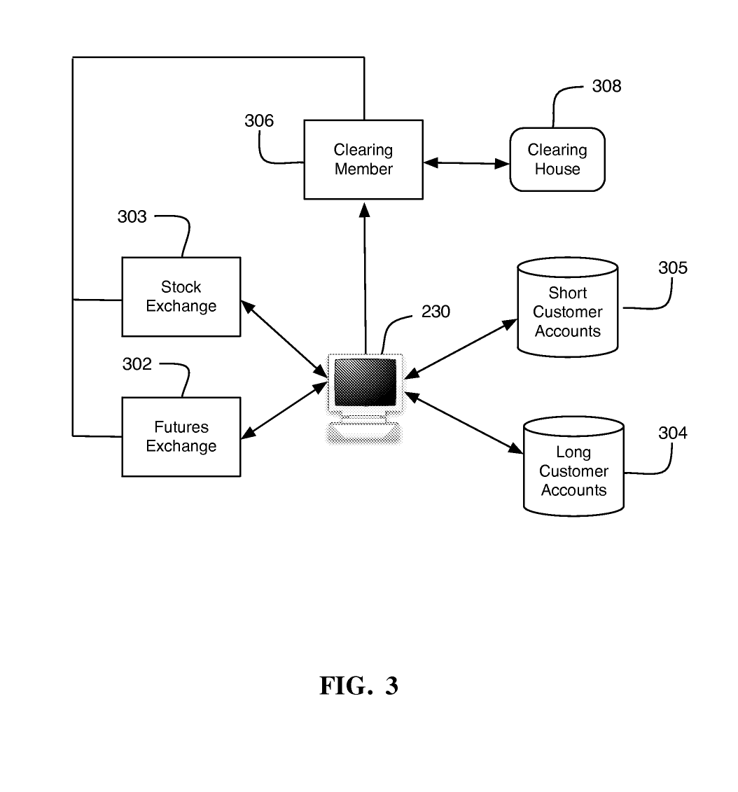

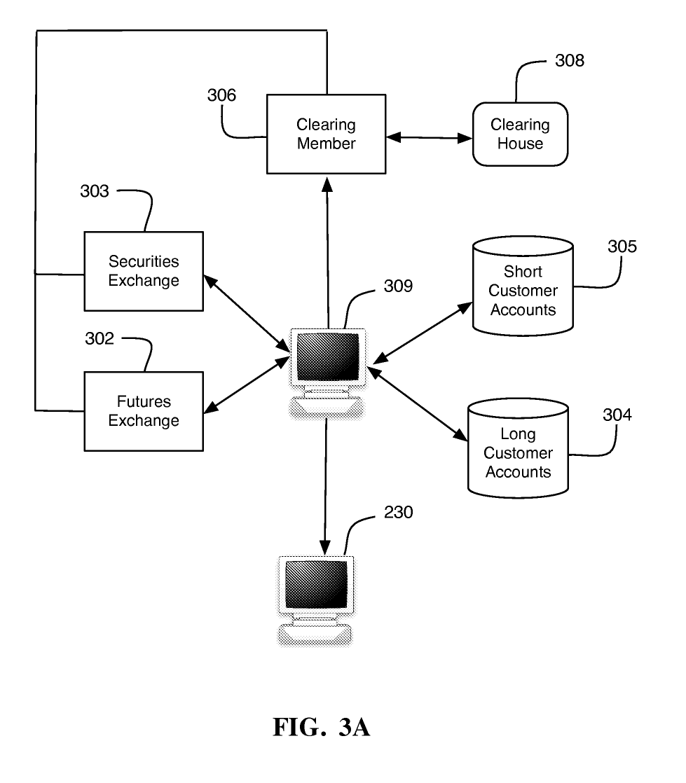

FIG. 3 shows an illustrative network for trading TradeDevil™ contracts and options on such contracts. A communication link between computer system 230 may be established to whatever exchange lists TradeDevil™ contracts, such as, for example, a futures exchange 302 or a stock exchange 303. Computer system 230 may receive a stream of real-time TradeDevil™ contract quotes from the exchange where the TradeDevil™ contracts are listed (e.g., futures exchange 302 or stock exchange 303). Trader user interface 238 and/or trader server 239 executing on computer system 230 may utilize an application programming interface (“API”) to receive streaming real-time quotes from, for example, futures exchange 302 or stock exchange 303 as input and display them to a trader via I/O device 235.

FIG. 3A illustrates an alternative client/server arrangement, where trader user interface 238 executes on computer system 230 and trader server 239 executes on another computer system 309. Computer system 309 may have a similar hardware architecture as computer system 230. It is understood that a trading system design may have various arrangements. When a trader enters an order for a TradeDevil™ contract or option on such a contract, the price will be tied to the quotes received from the exchange where the TradeDevil™ contracts are listed (e.g., futures exchange 302 or stock exchange 303).

Broker-dealers or any other trader may enter orders for their customers, for example, using computer system 230. Trader user interface 238 or trader server 239 may also utilize database APIs to write, update, or delete customer accounts from database 304 and 305. Database 304 and 305 may be implemented using known database products (e.g., SYBASE, ORACLE, SQL, etc.). TradeDevil™ contracts and options on such contracts may be listed for trading on futures exchange 302 registered with the CFTC. TradeDevil™ contracts and options on such contracts may also be listed on a stock exchange 303 or any other trading venue that is notice designated with the CFTC as a designated contract market and cleared through a CFTC or SEC designated clearing organization. Trades conducted in TradeDevil™ contracts and options on such contracts may be cleared and settled via clearing member 306 through its affiliation with a clearing house 308 which is preferably an organization established as such by the CFTC or SEC. Clearing member 306 preferably maintains a connection with stock exchange 303, futures exchange 302, or any other exchange where TradeDevil™ contracts are listed. Trader user interface 238 running on computer system 230, or trader server running on computer system 230 or 309 may also utilize appropriate APIs to enter, amend, delete, or update orders with futures exchange 302 or stock exchange 303.

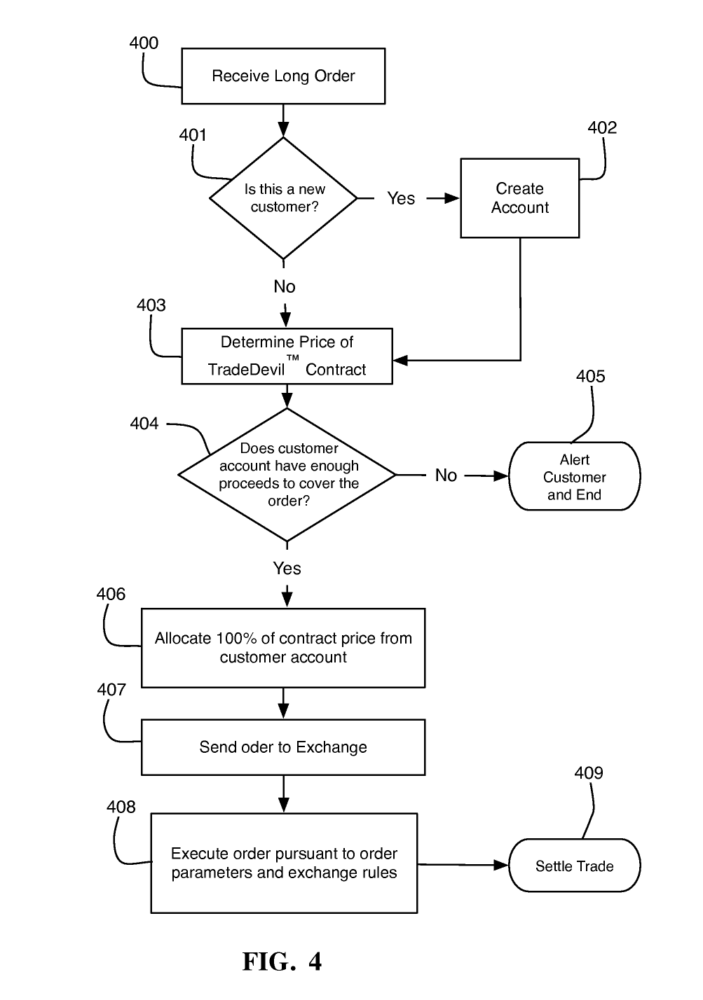

FIG. 4 illustrates a preferred sequence of steps for processing long orders of TradeDevil™ contracts. The preferred steps illustrated in FIG. 4 may be encoded in any known programming language (e.g., C++, C#, Java, etc.). The encoded steps may, for example, be programmed in trader user interface 238, trader server 239, or distributed between both. Other embodiments allow some of the encoded steps to be included in the exchange software. In step 400, an order may be received using trader user interface 238, or received using trader user interface 238 and sent to server 239 via, for example, an inter-process communication protocol. In step 401, the system determines whether a new or existing customer entered the order. If an existing customer, then the system proceeds to step 403 described below. If a new customer, the system creates a new account in the long customer database 304 in step 402 and then proceeds to step 403. Either trader user interface 238 or trader server 239 may initiate this procedure.

In step 403, the system determines the price of the TradeDevil™ contract by preferably using the real-time feed provided by the exchange where TradeDevil™ contracts are listed (e.g., stock exchange 303 or futures exchange 302). Next, in step 404, the system preferably determines whether the long customer account in database 304 has enough proceeds to cover, for example, 100% of the contract price or 50% if trading on margin. If the customer account does not have enough available proceeds to cover the order, then the system preferably alerts the customer that additional proceeds are required before proceeding in step 405.

If the system determines that the available balance in the customer's account is sufficient to cover the order, then the system preferably allocates 100% of the contract price from the account in step 406, which may be done in database 304 with special database commands initiated by trader user interface 238 or trader server 239. In step 407, the system may send the order to either exchange 302 or 303. Once exchange 302 or 303 receives the order, the exchanges are preferably responsible for order execution in step 408. The order parameters and exchange rules may determine when to proceed to step 409 and settle the trade.

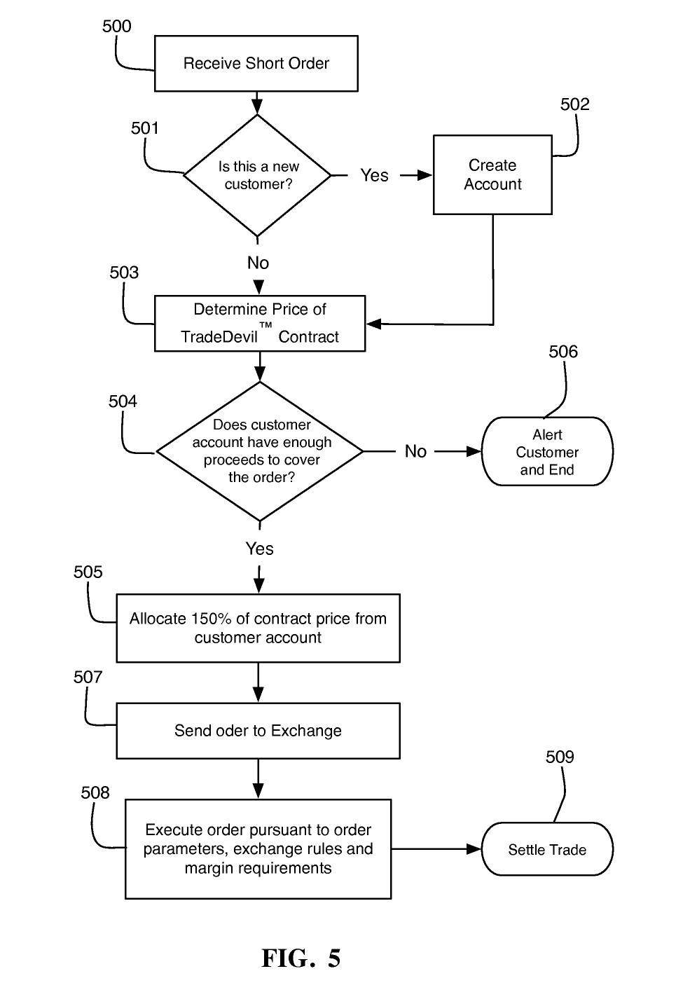

FIG. 5 illustrates a preferred sequence of steps for executing short orders. The preferred steps illustrated in FIG. 5 may be encoded in any known programming language (e.g., C++, C#, Java, etc.). The encoded steps may, for example, be programmed in trader user interface 238, trader server 239, or distributed between both. Other embodiments allow some of the encoded steps to be included in the exchange software.

In step 500, an order may be received using trader user interface 238, or received using trader user interface 238 and sent to server 239 via, for example, an inter-process communication protocol. In step 501, the system determines whether a new or existing customer entered the order. If an existing customer, then the system proceeds to step 503 described below. If a new customer, the system creates a new account in the short customer database 305 in step 502 and then proceeds to step 503. Either trader user interface 238 or trader server 239 may initiate this procedure.

In step 503, the system determines the price of the TradeDevil™ contract by preferably using the real-time feed provided by the exchange where TradeDevil™ contracts are listed (e.g., futures exchange 302 or stock exchange 303). Next, in step 504, the system preferably determines whether the short customer account in database 305 has enough proceeds to cover, for example, 150% of the contract price. If the customer account does not have enough available proceeds to cover the order, then the system preferably alerts the customer that additional proceeds are required before proceeding in step 506.

If the system determines that the available balance in the customer's account is sufficient to cover the order, then the system preferably allocates 150% of the contract price from the account in step 505, which may be done in database 305 with special database commands initiated by trader user interface 238 or trader server 239. In step 507, the system may send the order to either exchange 302 or 303. Once exchange 302 or 303 receives the order, the exchanges are preferably responsible for order execution in step 508. The order parameters and exchange rules may determine when to proceed to step 509 and settle the trade. For example, the system may be configured to ensure that the margin requirement is maintained in the customer's account in order to proceed to settlement.

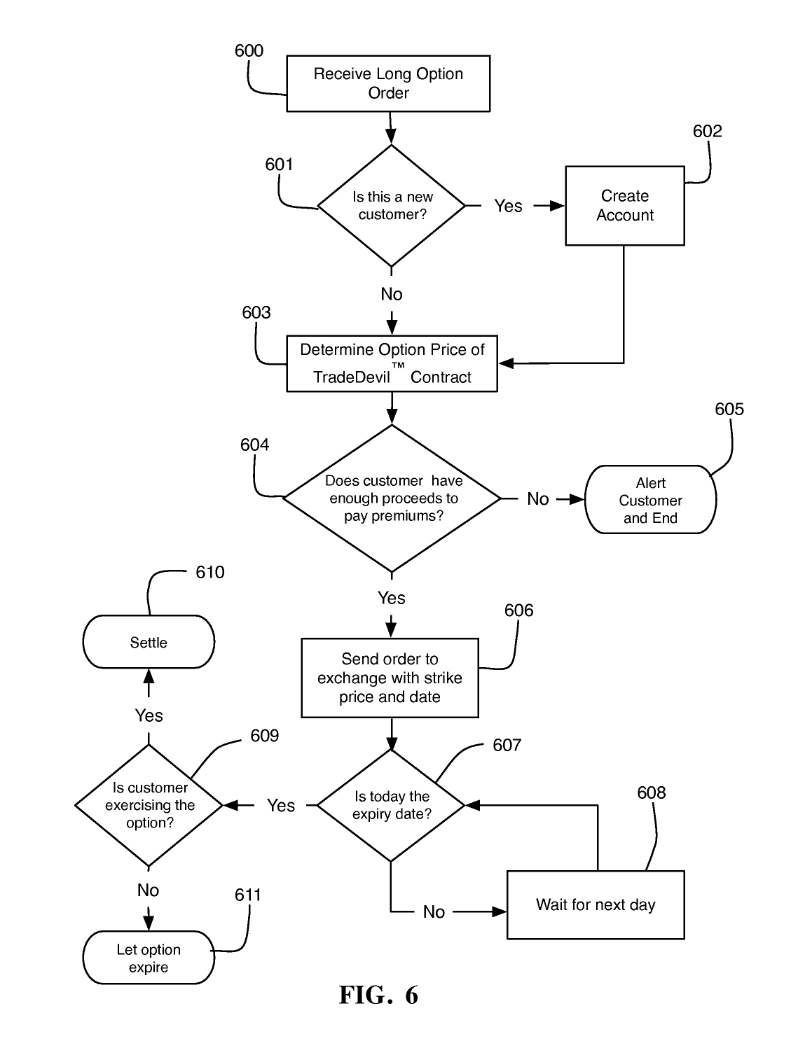

FIG. 6 illustrates a preferred sequence of steps for processing long option orders of TradeDevil™ contracts. The preferred steps illustrated in FIG. 6 may also be encoded in any known programming language (e.g., C++, C#, Java, etc.). Some of the encoded steps may also be programmed in trader user interface 238, trader server 239, or distributed between both the trader user interface 238 and trader server 239. In one embodiment, the encoded steps may also be distributed to the exchange.

In step 600, a long options order of TradeDevil™ contracts may be received using trader user interface 238, or received using trader user interface 238 and sent to server 239 via, for example, an inter-process communication protocol. In step 601, the system determines whether an existing or new customer entered the order. If an existing customer, the system proceeds to step 603. If a new customer, the system creates a new account in long customer database 304 in step 602. Either trader user interface 238 or trader server 239 may initiate this procedure.

In step 603, the system determines the option price of the TradeDevil™ contract by preferably using the real-time feed provided by the exchange where TradeDevil™ contracts are listed (e.g., futures exchange 302 or stock exchange 303). Next, in step 604, the system determines whether there are enough proceeds in the long customer account in database 304 to cover the premiums for the options. If sufficient proceeds exist, the system proceeds to step 606. Otherwise, the system notifies the customer that insufficient funds exist to complete the order in step 605.

In step 606, the system may send the order to either exchange 302 or 303. Once exchange 302 or 303 receives the order, the exchanges are preferably responsible for execution of the order. The exchange 302, 303 may have systems in place to verify whether the option has expired, as illustrated in step 607. If not, another verification may take place the following day, as illustrated in step 608. Once the expiry date arrives, the system determines whether the customer is going to exercise the option in step 609. If the customer elects to exercise the option, the system settles the option in step 610 by, for example, either physically settling the option by delivery of the TradeDevil™ contract or cash settling the option by delivery of the cash equivalent of the TradeDevil™ contract. Otherwise, the option expires in step 611.

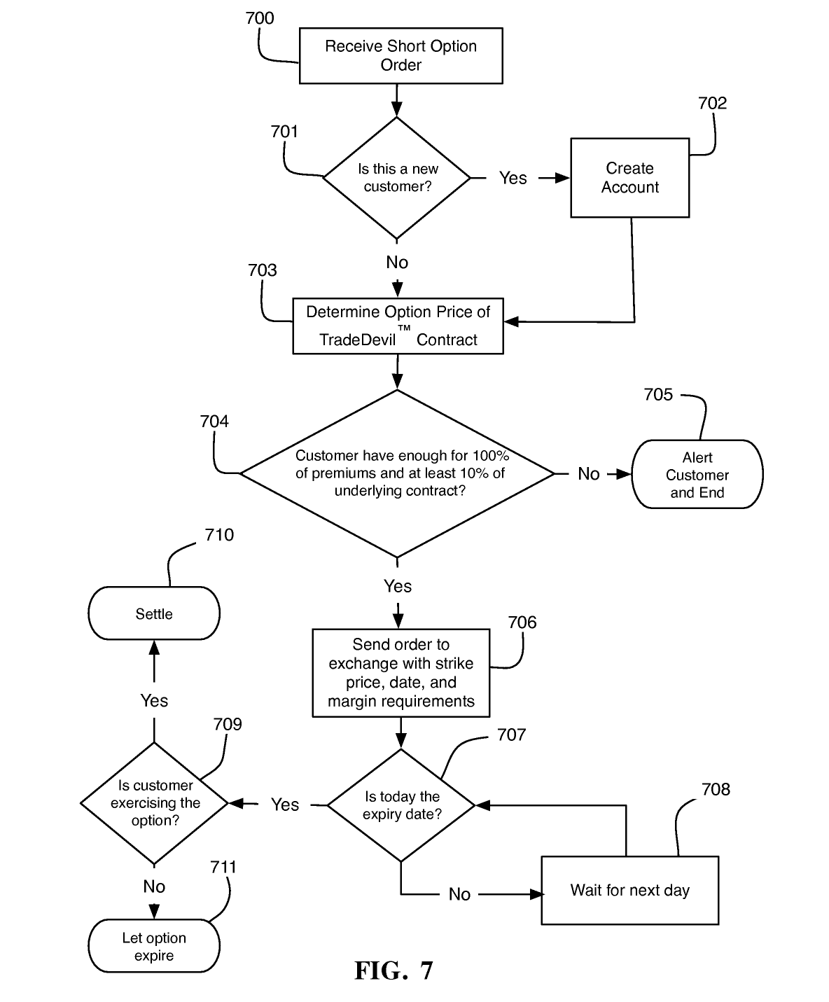

A preferred sequence of steps for processing short option orders of TradeDevil™ contracts is illustrated in FIG. 7. The preferred steps illustrated in FIG. 7 may also be encoded in any known programming language (e.g., C++, C#, Java, etc.). Some of the encoded steps may also be programmed in trader user interface 238, trader server 239, or distributed between both the trader user interface 238 and trader server 239. In one embodiment, the encoded steps may also be distributed to the exchange.

In step 700, a short options order of TradeDevil™ contracts may be received using trader user interface 238, or received using trader user interface 238 and sent to server 239 via, for example, an inter-process communication protocol. In step 701, the system determines whether an existing or new customer entered the order. If an existing customer, the system proceeds to step 703. If a new customer, the system creates a new account in short customer database 305 in step 702. Either trader user interface 238 or trader server 239 may initiate this procedure.

In step 703, the system determines the option price of the TradeDevil™ contract by preferably using the real-time feed provided by the exchange where TradeDevil™ contracts are listed (e.g., futures exchange 302 or stock exchange 303). Next, in step 704, the system determines whether there are enough proceeds in the short customer account in database 305 to cover the premiums for the options and any additional amount. For example, the system may verify that the short customer account maintains enough proceeds to cover 100% of the premiums and at least 10% (e.g., 20%) of the underlying contract. If sufficient proceeds exist, the system proceeds to step 706. Otherwise, the system notifies the customer that insufficient funds exist to complete the order in step 705.

In step 706, the system may send the order with the strike price, date and margin requirements to either exchange 302 or 303. Once exchange 302 or 303 receives the order, the exchanges are preferably responsible for execution of the order. The exchange 302, 303 may have systems in place to verify whether the option has expired, as illustrated in step 707. If not, another verification may take place the following day, as illustrated in step 708. Once the expiry date arrives, the system determines whether the customer is going to exercise the option in step 709. If the customer elects to exercise the option, the system settles the option in step 710 by, for example, either physically settling the option by delivery of the TradeDevil™ contract or cash settling the option by delivery of the cash equivalent of the TradeDevil™ contract. Otherwise, the option expires in step 711.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A computer implemented method for trading a non-traditional futures contract representative of a price of an individual underlying commodity, comprising:
receiving a request from a customer to establish a position in the non-traditional futures contract of an individual underlying commodity;
determining a contract price of the non-traditional futures contract based on the current market price of the individual underlying commodity;
determining whether available funds within an account corresponding to the customer exceed a predetermined amount;
establishing the non-traditional futures contract for the individual underlying commodity without any obligation to deliver or receive the commodity;
calculating the difference between the contract price and the market price of the individual underlying commodity at the expiration of the contract; and
settling the customer's account based on the difference between the contract price and the market price of the individual underlying commodity at the expiration of the contract.

2. The method according to claim 1, wherein the position is a long position in the non-traditional futures contract of an individual underlying commodity.

3. The method according to claim 2, wherein the predetermined amount equals 100% of the contract price of the non-traditional futures contract of an individual underlying commodity.

4. The method according to claim 2, wherein the customer is not subject to any additional payments throughout the life of the long position in the non-traditional futures contract of an individual underlying commodity.

5. The method according to claim 1, wherein the position is a short position in the non-traditional futures contract of an individual underlying commodity.

6. The method according to claim 5, wherein the predetermined amount equals at least 100% of the contract price of the non-traditional futures contract of an individual underlying commodity plus an additional amount of at least 10% of the current market price of the underlying commodity.

7. The method according to claim 6, wherein the additional amount equals 50% of the current market price of the individual underlying commodity.

8. A system for trading a non-traditional futures contract representative of a price of an individual underlying commodity, comprising:
a database for storing information representing available funds within an account corresponding to the customer; and
a processor for receiving a request from a customer to establish a position in the non-traditional futures contract of an individual underlying commodity, the processor executing commands to:
determine a contract price of the non-traditional futures contract based on the current market price of the individual underlying commodity;
determine whether available funds within the customer account exceed a predetermined amount;
establish the position in the non-traditional futures contract for the individual underlying commodity without any obligation to deliver or receive the commodity;
calculate the difference between the contract price and the market price of the individual underlying commodity at the expiration of the contract; and
settle the customer's account based on the difference between the contract price and the market price of the individual underlying commodity at the expiration of the contract.

9. The system according to claim 8, wherein the position is a long position in the non-traditional futures contract of an individual underlying commodity.

10. The system according to claim 9, wherein the predetermined amount equals 100% of the contract price of the non-traditional futures contract of an individual underlying commodity.

11. The system according to claim 9, wherein the customer is not subject to any additional payments throughout the life of the long position in the non-traditional futures contract of an individual underlying commodity.

12. The system according to claim 8, wherein the position is a short position in the non-traditional futures contract of an individual underlying commodity.

13. The system according to claim 12, wherein the predetermined amount equals at least 100% of the contract price of the non-traditional futures contract of an individual underlying commodity plus an additional amount of at least 10% of the current market price of the underlying commodity.

14. The system according to claim 13, wherein the additional amount equals 50% of the current market price of the individual underlying commodity.

15. A computer implemented method for trading options on an underlying non-traditional futures contract representative of a price of an individual underlying commodity, comprising:
receiving a request from a customer to establish a position in an option on the non-traditional futures contract of an individual underlying commodity;
determining a contract price of the underlying non-traditional futures contract based on the current market price of the individual underlying commodity;
determining whether available funds within an account corresponding to the customer exceed a predetermined amount;
establishing the option on the non-traditional futures contract for the individual underlying commodity without any obligation to deliver or receive the commodity; and
settling the customer's account if the option is exercised.

16. The method according to claim 15, further comprising:
calculating the difference between the contract price and the market price of the individual underlying commodity at the expiration; and
settling the customer's account based on the difference between the contract price and the market price of the individual underlying commodity at the expiration of the contract.

17. The method according to claim 15, wherein the account is settled by delivering the non-traditional futures contract of the individual underlying commodity.

18. The method according to claim 15, wherein the position is a long position in the option on the non-traditional futures contract of an individual underlying commodity.

19. The method according to claim 18, wherein the predetermined amount equals 100% of the contract price of the non-traditional futures contract of an individual underlying commodity.

20. The method according to claim 19, wherein the customer is not subject to any additional payments throughout the life of the long position in the option on non-traditional futures contract of an individual underlying commodity.

21. The method according to claim 15, wherein the position is a short position in the option on the non-traditional futures contract of an individual underlying commodity.

22. The method according to claim 21, wherein the predetermined amount equals at least 100% of the contract of the non-traditional futures contract of an individual underlying commodity plus an additional amount of at least 10% of the current market price of the underlying commodity.

23. A system for trading an option on a non-traditional futures contract representative of a price of an individual underlying commodity, comprising:
a database for storing information representing available funds within an account corresponding to the customer; and
a processor for receiving a request from a customer to establish a position in an option on the non-traditional futures contract of an individual underlying commodity, the processor executing commands to:
determine a contract price of the non-traditional futures contract based on the current market price of the individual underlying commodity;
determine whether available funds within the customer account exceed a predetermined amount;
establish the position in the option on the non-traditional futures contract for the individual underlying commodity without any obligation to deliver or receive the commodity;
settle the customer's account if the option is exercised.

24. The system according to claim 23, wherein the processor executes commands to:
calculate the difference between the contract price and the market price of the individual underlying commodity at the expiration; and
settle the customer's account based on the difference between the contract price and the market price of the individual underlying commodity at the expiration of the contract.

25. The system according to claim 23, wherein the processor executes commands to settle the account by delivering the non-traditional futures contract of the individual underlying commodity.

26. The system according to claim 23, wherein the position is a long position in the option on the non-traditional futures contract of an individual underlying commodity.

27. The method according to claim 26, wherein the predetermined amount equals 100% of the contract price of the non-traditional futures contract of an individual underlying commodity.

28. The method according to claim 26, wherein the customer is not subject to any additional payments throughout the life of the long position in the option on non-traditional futures contract of an individual underlying commodity.

29. The method according to claim 23, wherein the position is a short position in the option on the non-traditional futures contract of an individual underlying commodity.

30. The method according to claim 29, wherein the predetermined amount equals at least 100% of the contract of the non-traditional futures contract of an individual underlying commodity plus an additional amount of at least 10% of the current market price of the underlying commodity.

31. A system for trading a non-traditional futures contract representative of the price of an individual underlying commodity, comprising:
means for receiving a request from a customer to establish a position in the non-traditional futures contract of an individual underlying commodity;
means for determining a contract price of the non-traditional futures contract based on the current market price of the individual underlying commodity;
means for determining whether available funds within an account corresponding to the customer exceed a predetermined amount;
means for establishing the non-traditional futures contract for the individual underlying commodity without any obligation to deliver or receive the commodity;
means for calculating the difference between the contract price and the market price of the individual underlying commodity at the expiration of the contract; and
means for settling the customer's account based on the difference between the contract price and the market price of the individual underlying commodity at the expiration of the contract.

32. The system according to claim 31, wherein the non-traditional futures contract includes an option on such a contract.
